(19) United States
(12) Patent Application Publication
(10) Pub. No.: US 2021/0088092 A1
(43) Pub. Date: Mar. 25, 2021

(54) Brake Disc/Hub Connection

(71) Applicant: KNORR-BREMSE Systeme fuer Nutzfahrzeuge GmbH, Muenchen (DE)

(72) Inventors: Wolfgang PAHLE, Bad Wiessee (DE); Stephan KOTTEDER, Osterhofen (DE)

(21) Appl. No.: 16/772,274

(22) PCT Filed: Dec. 4, 2018
(86) PCT No.: PCT/EP2018/083450

§ 371 Date: Jun. 12, 2020

(30) Foreign Application Priority Data
Dec. 13, 2017 (DE) 10 2017 129 684.0

(51) Int. Cl. F16D 65/12; B60B 27/00

(52) U.S. Cl. CPC F16D 65/123; F16D 2065/1384; B60B 27/0052

(57) ABSTRACT

A brake disc/hub connection has a hub with a wheel flange and drivers which extend from the wheel flange in the axial direction with respect to a rotational axis of the hub, a brake disc from the interior circumference of which support elements protrude in the direction of the rotational axis, wherein the drivers engage in a tooth-like fashion between the support elements. First intermediate elements with sections are arranged between the lateral flanks of the drivers and the support elements, wherein the intermediate elements are secured to the support elements, wherein each of the sections bears in a planar fashion on a flank of the respective support element.

### BACKGROUND AND SUMMARY OF INVENTION

The present invention relates to a brake disc/hub connection.

For example, generic brake disc/hub connections are known from DE 10 2014 107 228 A1 or DE 199 18 069 A1. It is important for these brake disc/hub connections that the friction ring of the brake disc can extend radially to improve the heat crack resistance of the brake discs. For this purpose, the hub has multiple drivers extending axially with respect to an axis of rotation of the hub of a wheel flange, which engage tooth-like between support elements extending from an inner circumference of a brake disc.

Intermediate elements inserted between the support elements and the drivers are used to reduce heat input to the hub caused by a braking process.

Known brake disc/hub connections have proven themselves in practice. It is nevertheless desirable to facilitate the assembly of the components, especially the intermediate elements.

The object of the present invention is to provide a brake disc/hub connection, with which assembly is further simplified.

The brake disc/hub connection according to the invention has a hub with a wheel flange and drivers, which extend away from the wheel flange in the axial direction with respect to an axis of rotation of the hub. Support elements, which extend in the direction of the rotation axis, protrude from the inner circumference of the brake disc. The drivers of the hub engage tooth-like between the support elements of the brake disc. The brake disc/hub connection also has first intermediate elements with sections connected between the lateral flanks of the drivers and the support elements.

In a first variant, the intermediate elements are fixed on the support elements, wherein each of the sections is in planar contact with a flank of the respective support element.

As a result, the installation effort is significantly reduced compared to known solutions, since the first intermediate elements can now be pre-assembled on the brake disc.

In a preferred embodiment variant, each of the intermediate elements has two separate sections spaced apart from each other, which are connected to each other by a crossbar in contact with an inner circumferential surface of the brake disc. Here, a first of the sections is in contact with a first of the supporting elements and a second of the sections is in contact with a second of the support elements, which is separated from the first of the supporting elements by a space between them.

Due to such a u-shaped design of the first intermediate elements, these can be fixed between two adjacent support elements of the brake disc in a simple way.

According to an alternative embodiment of the brake disc/hub connection according to the invention, each of the intermediate elements has exactly one section in planar contact with a flank of the respective support element, from which two clamping bars extend, which are in contact with the support element on both sides, thus fixing the intermediate element axially.

Such an intermediate element can also be easily mounted on the brake disc before assembling the brake disc and hub.

According to a further advantageous embodiment variant, second intermediate elements mounted separately from first intermediate elements can be arranged between the lateral flanks of the drivers and the sections of the first intermediate elements.

Due to the second intermediate elements, a further reduction of the thermal input into the hub is possible.

According to a preferred embodiment variant, the second intermediate elements have a contact surface in planar contact with the section of the respective first intermediate element and a spring tongue extending at an angle, in particular perpendicularly thereto which bear on a front surface of the support element, which allows a slightly sprung mounting of the brake disc relative to the hub in the axial direction.

The first intermediate elements have a positive connection to the second intermediate elements according to a further preferred embodiment version.

As a result it is ensured that the second intermediate elements are installed correctly.

Particularly preferably, for this purpose the first intermediate elements have a recess in the transition region between the section and at least one of the clamping bars for the positive acceptance of a tongue which is bent at an angle to a contact surface of the second intermediate elements.

The contact surface of the second intermediate element is formed with a wedge shape according to a further preferred embodiment variant, which allows the flanks of the drivers or the support elements to be orientated at an angle to each other.

Moreover, this allows tolerances of the gaps between the drivers and the support elements to be reduced by a calibration process, resulting in an increase in the sustainable dynamic load.

For radially securing the second intermediate elements, according to a further preferred embodiment variant, the free ends of the sections of the first intermediate elements extending approximately radially to the axis of rotation are in the form of inwardly bent retaining bars extending axially with respect to the axis of rotation, on which lateral edges of the sections of the second intermediate element are radially supported.

According to a further embodiment variant of a brake disc/hub connection according to the invention, lateral flanks of the drivers and lateral flanks of the support elements are at an angle to each other and the sections of the intermediate elements in planar contact between the flanks of the drivers and the support elements are wedge-shaped.

This allows a play-free connection between the drivers and the support elements by radial displacement of the intermediate element.

According to a preferred embodiment variant, a crossbar of the intermediate element connecting the sections to each other is in contact with a rear side of the driver facing a wheel flange of the hub.

The lateral flanks of the drivers are preferably oriented at an angle of 10° to 35° to the lateral flanks of the support elements.

According to a further advantageous embodiment, the sections of the intermediate elements in planar contact between the flanks of the drivers and the support elements are formed tapering away from the axis of rotation. This in turn makes it possible to orient the flanks of the drivers and the support elements at an angle to each other.

According to a further embodiment variant of a brake disc/hub connection according to the invention, two identical intermediate elements are arranged between the lateral flanks of the drivers and the support elements in each case, wherein each of the intermediate elements has a spring tongue extending at an angle, in particular perpendicularly to the respective section and wherein the spring tongue of a first of the intermediate elements is in contact with a front surface of the respective support element and the spring tongue of a second of the intermediate elements is in contact with a rear contact surface of the respective support element.

Preferred exemplary embodiments are explained below in more detail on the basis of the enclosed drawings.

### BRIEF DESCRIPTION OF THE DRAWINGS

FIG. 1 shows a perspective view of an embodiment variant of a brake disc with support elements and intermediate elements arranged between the support elements.

FIGS. 2 and 3 show perspective representations of the intermediate elements shown in FIG. 1.

FIG. 4 shows a perspective representation of a brake disc with intermediate elements arranged on the support elements according to an alternative embodiment variant.

FIGS. 5 to 7 show different representations of the intermediate elements according to FIG. 5.

FIG. 8 shows a perspective representation of a section of a brake disc with intermediate elements arranged thereon with an alternative embodiment variant of second intermediate elements.

FIG. 9 shows a top view on a brake disc/hub connection with intermediate elements according to a further alternative embodiment variant.

FIG. 10 shows a perspective sectional representation of a hub and a driver with an intermediate element arranged thereon.

FIG. 11 shows a perspective representation of the intermediate elements shown in FIG. 10.

FIGS. 12 and 13 show two different views of a brake disc/hub connection with further alternatively executed intermediate elements.

### DETAILED DESCRIPTION OF THE DRAWINGS

In the following figure description, terms such as top, bottom, left, right, front, rear, etc. refer exclusively to the exemplary representation and position of the brake disc/hub connection, the hub, the brake disc, the wheel flange, the drivers, the support elements, the intermediate elements and the like chosen in the respective figures. These terms are not to be understood as restrictive, i.e. these terms may change due to different working positions or a mirror-symmetrical configuration or the like.

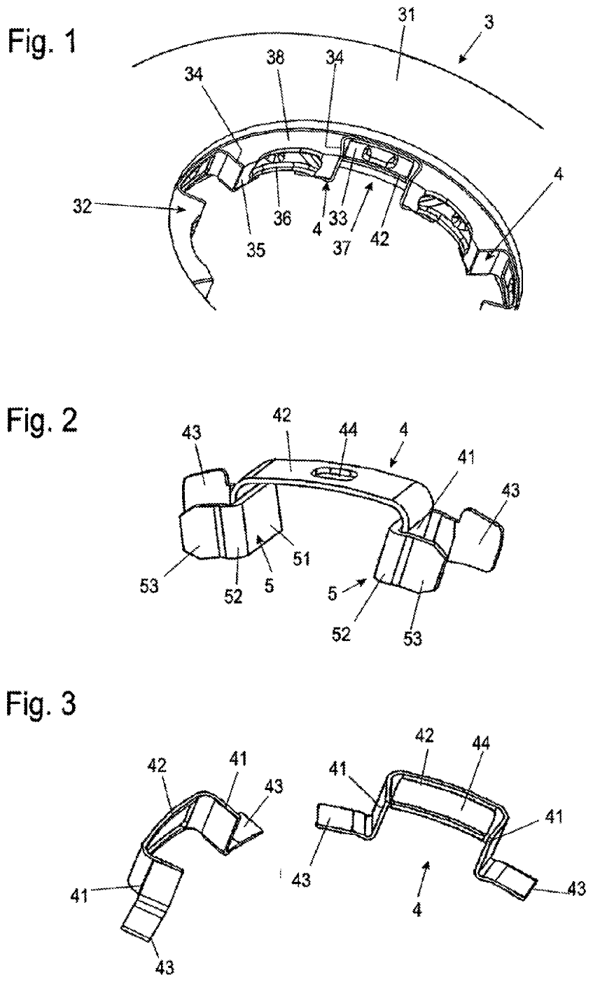

In FIG. 1, a brake disc 3 of a brake disc/hub connection is represented, with two friction rings 31 and support elements 32 arranged on an inner circumference 33 extending radially inwards, spaced apart from each other, and evenly distributed over the circumference.

Between the support elements 32, recesses 37 are provided, in which drivers 22 of a hub 2 extend radially outwards away from a wheel flange 21 of the hub 2. Such a hub 2 is shown as an example in FIGS. 9, 10 and 13. The drivers 22 extend from the wheel flange 21 in the axial direction with respect to an axis of rotation A of the hub 2 and the brake disc 3.

As is further shown in FIG. 1, first intermediate elements 4 are arranged in the region of the recesses 37 of the brake disc 3.

The intermediate elements 4 shown in detail in FIG. 3 have sections 41 arranged between lateral flanks 24, 34 of the drivers 22 and the support elements 32.

The intermediate elements 4 are fixed on the support elements 32. Each of the sections 41 is in planar contact with a flank 34 of the respective support element 32.

In this case, each of these intermediate elements 4 has two sections 41 spaced apart from each other, which are connected to each other by a crossbar 42 in contact with an inner circumferential surface 33 of the brake disc 3. A first of the sections 41 is in contact with a first of the support elements 32 and a second of the sections 41 is in contact with a second of the support elements 32, which is separated from the first of the support elements 32 by an intermediate space 37. The two sections 41 and the crossbar 42 form a u shape.

As shown in FIGS. 1 to 3, the crossbar 42 preferably has an opening 44. As is further shown in FIG. 3, separating surfaces 43 formed on the sections 41, which are in contact with the flanks of the support elements 32, are bent perpendicular to the sections 41, and when mounted on the brake disc 3 are in planar contact with the rear side of the support elements 32 facing the wheel flange 21.

As shown in FIG. 2, second intermediate elements 5 that can be fitted separately from the first intermediate elements 4 are arranged between the lateral flanks 24 of the drivers 22 and the sections 41 of the first intermediate elements 4.

The second intermediate elements 5 are preferably L-shaped, with a contact surface 51 in planar contact with the section 41 of the respective first intermediate elements 4 and a spring tongue 53 extending at an angle, in particular perpendicularly thereto, which bears on a front surface 38 of the support element 32.

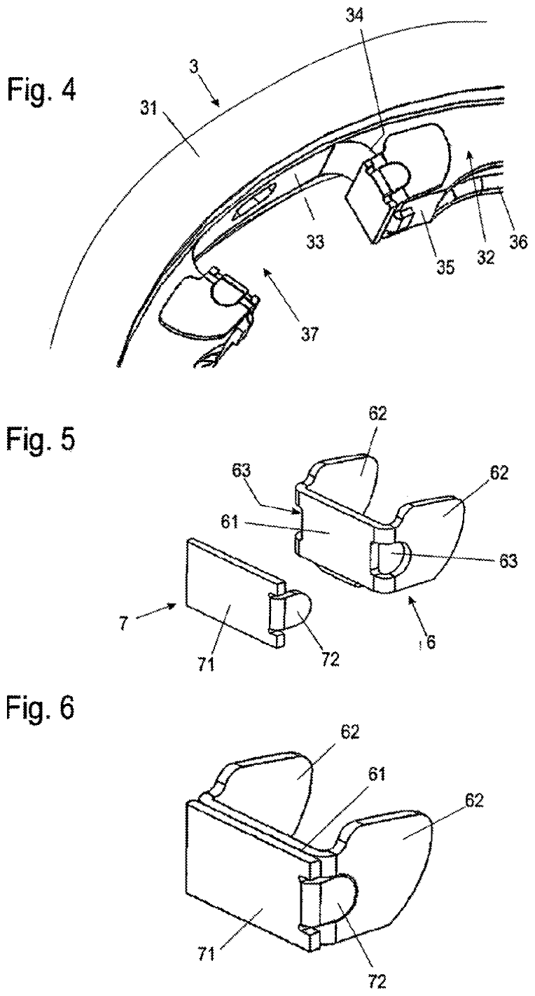

In the version of the brake disc/hub connection shown in FIGS. 4 to 8, the first intermediate elements 6 are also formed in a u shape. However, in this embodiment variant, in each case one of the intermediate elements 6 is mounted on a flank 34 of a single support element 32.

Thus, each of these intermediate elements 6 has exactly one section 61 in planar contact with a flank 34 of the respective support element 32, from which two clamping bars 62 extend, which fix the intermediate element 6 axially and engage around the support element 32 on both sides while making contact therewith.

As can easily be seen in FIGS. 4 to 6, a second intermediate element 7 is placed on each of the first intermediate elements 6, with a contact surface 71 and a tongue 72 bent at an angle to the contact surface.

The tongue 72 is used here for the positive fixing of the second element 7 on the first intermediate element 6.

For this purpose, in the first intermediate element 6 a recess 63, in which the tongue 72 of the second intermediate element 7 is accepted, as shown in FIG. 6, is provided at least in a transition region between the section 61 and one of the clamping bars 62.

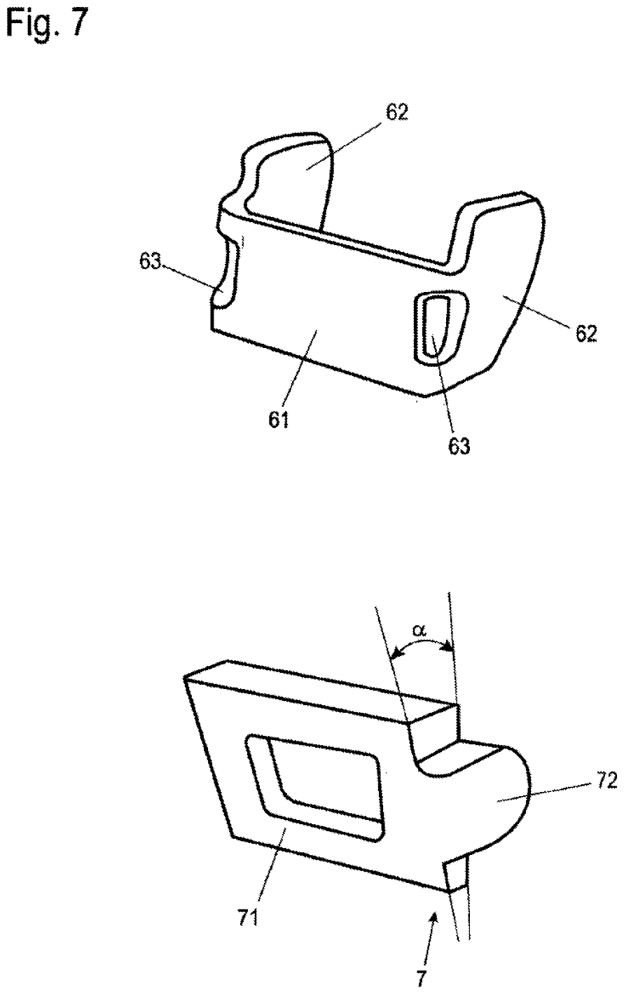

With the embodiment variants of the first and second elements 6, 7 shown in FIG. 7, the contact surface 71 of the second intermediate element 7 is formed in a wedge shape. In this case, in the mounted state the edge of the second intermediate element 7 closer to the axis of rotation A is narrower than the edge of the second intermediate element 7 further away from the axis of rotation A.

This allows an angular shape of the flanks 34 of the supporting element 32 relative to the flanks 24 of the drivers 22.

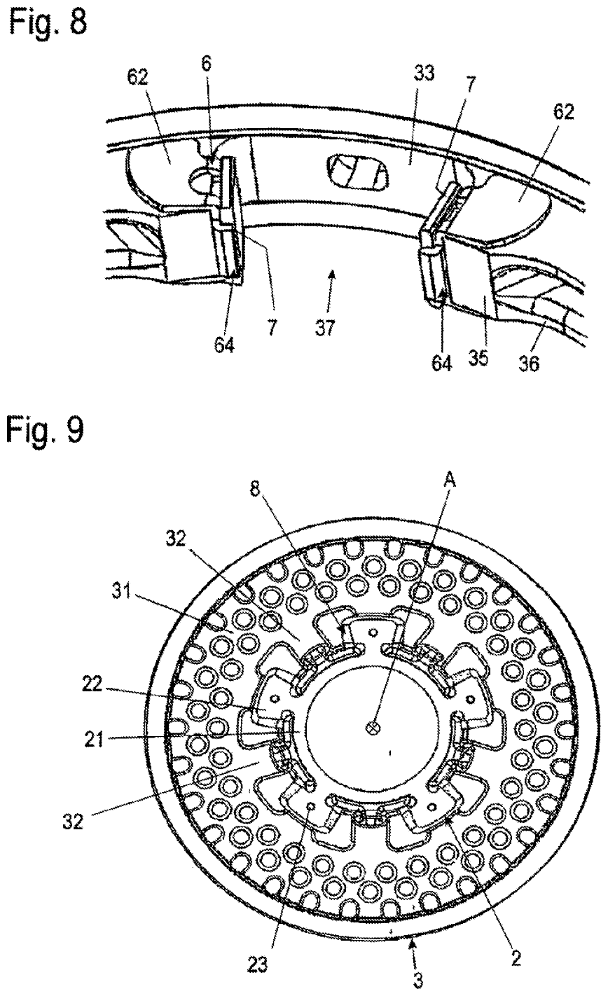

With the embodiment variant shown in FIG. 8, the second intermediate elements 7 are implemented as plain surface elements.

For radial retention of these second intermediate elements 7, the free ends of the sections 61 of the first intermediate elements 6 extending approximately radially with respect to the axis of rotation A are formed as inwardly bent retaining bars 64 extending axially with respect to the axis of rotation A, on the lateral edges of which the sections 71 of the second intermediate elements 7 are radially supported.

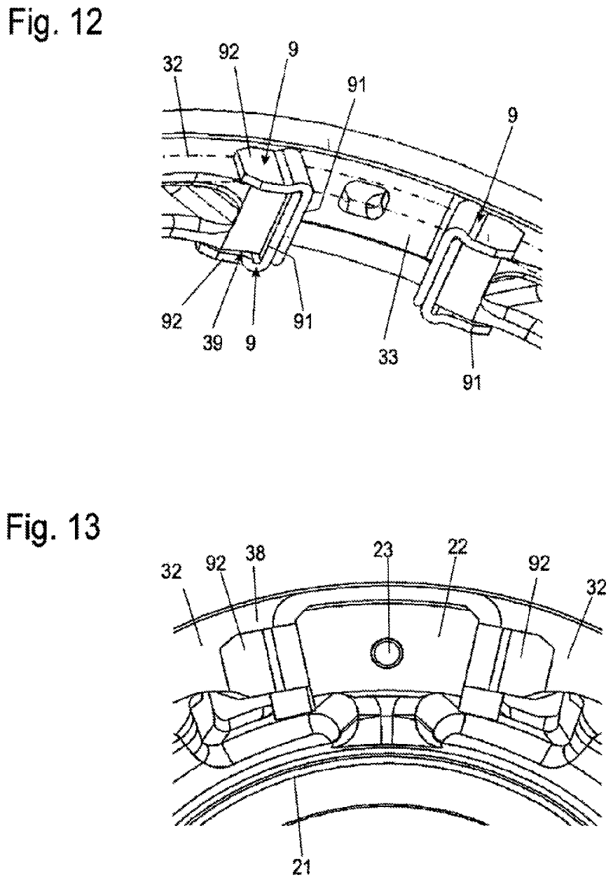

In the embodiment variant of a brake disc/hub connection shown in FIGS. 12 and 13, sections 91 of two identically constructed intermediate elements 9 are arranged between the lateral flanks 24, 34 of the drivers 22 and the support elements 32.

The intermediate elements 9 each have a spring tongue 92 extending at an angle, in particular perpendicularly to the respective section 91.

The spring tongue 92 of a first of the intermediate elements 9 is thereby in contact with a front surface 38 of the respective support element 32. The spring tongue 92 of the second intermediate element bearing on the first intermediate element 9 is thereby in contact with a rear side contact surface 39 of the respective support element 32.

This embodiment variant also allows easy assembly and is additionally characterized by identically constructed first and second elements 9.

In FIGS. 9 to 11, another alternative embodiment variant of a brake disc/hub connection is shown.

With this embodiment variant, the intermediate elements 8 are pre-assembled on the drivers 22. The intermediate elements 8 have respective sections 81, which are in planar contact with the mutually opposing flanks 24 of the drivers 22.

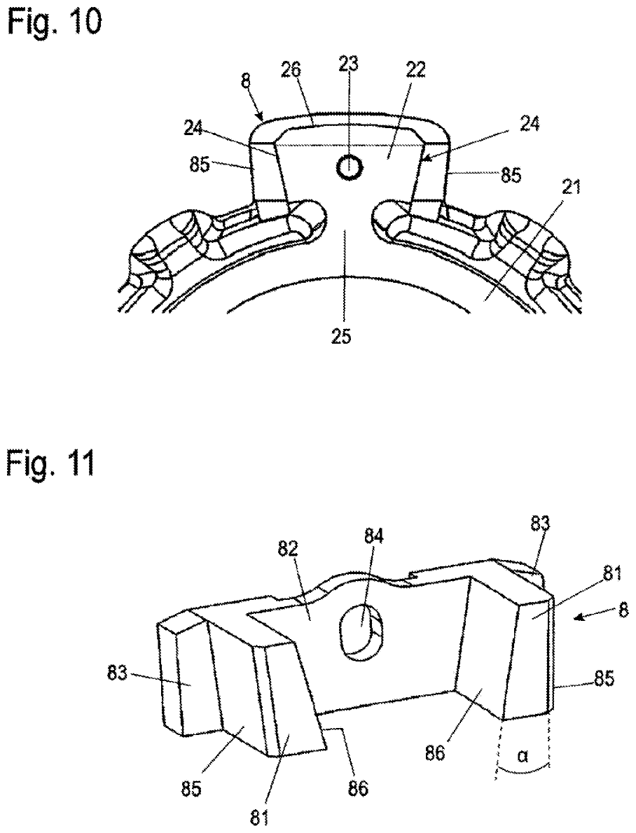

The lateral flanks 24 of the drivers 22 and the lateral flanks 34 of the support elements 32 are, as shown in FIG. 10, oriented at an angle to each other. The planar contacting sections 81 of the intermediate elements 8 in planar contact between the flanks 24, 34 of the driver 22 and the supporting elements 32 are wedge shaped.

An individual representation of such an intermediate element 8 is shown in FIG. 11.

As can be clearly seen here, the sections 81 are connected by a crossbar 82. In the mounted state of the intermediate element 8, this crossbar 82 is in contact with the rear side 26 of the driver 22 facing the wheel flange of the hub 2.

The lateral flanks 24 of the drivers 22 are preferably oriented at an angle α of 10° to 35° to the lateral flanks 34 of the support elements 32.

Accordingly, the outer sides 85 of the sections 81 of the intermediate elements 8 are oriented at an angle, preferably at an angle of 10° to 35° to the inner sides 86, which are in contact with the lateral flanks 24 of the drivers 22 in the mounted state.

The drivers 22 have, as is shown in FIG. 10, a central bore 23 on a front surface of the respective driver 22 facing away from the wheel flange 21, which is used to accommodate a screw or a bolt.

A corresponding recess 84 is also provided at the appropriate place in the crossbar 82 of the intermediate element 8.

For axial support of the intermediate elements 8 on the brake disc 3, dividers 83 extend in the circumferential direction outside the sections 81, which dividers 83 are in contact with a rear side of the supporting elements 32 of the brake disc 3.

### REFERENCE CHARACTER LIST

2 Hub
21 Wheel flange
22 Driver
23 Screw hole
24 Flanks
25 Support strut
26 Rear side
3 Brake disc
31 Friction ring
32 Support element
33 Circumferential surface
34 Flank
35 Circumferential surface
36 Recess
37 Recess
38 Front surface
39 Rear contact surface
4 First intermediate element
41 Section
42 Crossbar
43 Dividing surface
44 Opening
5 Second intermediate element
51 Contact surface
52 Bent region
53 Spring tongue
6 First intermediate element
61 Section
62 Clamping bar
63 Recess
64 Retaining bar
7 Second intermediate element
71 Contact surface
72 Tongue
8 First intermediate element
81 Section
82 Crossbar
83 Divider
84 Opening
85 Outer surface
86 Inner surface
9 Intermediate element
91 Contact surface
92 Spring tongue
Axis of rotation
α Angle

1.-14. (canceled)

15. A brake disc/hub connection, comprising:
a hub with a wheel flange and drivers which extend from the wheel flange in the axial direction with respect to an axis of rotation of the hub;
a brake disc from an inner circumference of which support elements extend in the direction of the axis of rotation,
wherein the drivers engage in a toothed manner between the support elements;
first intermediate elements with sections arranged between lateral flanks of the drivers and the support elements,
wherein the first intermediate elements are fixed on the support elements, and each of the sections is in planar contact with a flank of a respective support element.

16. The brake disc/hub connection as claimed in claim 15, wherein
each of the intermediate elements has two separate sections, which are connected to each other by a crossbar in contact with an inner circumferential surface of the brake disc, and
a first of the sections is in contact with a first of the support elements and a second of the sections is in contact with a second of the support elements, which is separated from the first of the support elements by a space.

17. The brake disc/hub connection as claimed in claim 15, wherein
each of the first intermediate elements has exactly one section in planar contact with a flank of the respective support element, from which two clamping bars extend, which clamping bars contact both sides of the support element while fixing the intermediate element axially.

18. The brake disc/hub connection according to claim 15, further comprising:
second intermediate elements, which are mounted separately from the first intermediate elements, and are arranged between the lateral flanks of the drivers and the sections of the first intermediate elements.

19. The brake disc/hub connection as claimed in claim 18, wherein
the second intermediate elements have a contact surface in planar contact with the section of the respective first intermediate element, and have a spring tongue extending at an angle, which is in contact with a front surface of the support element.

20. The brake disc/hub connection as claimed in claim 18, wherein
the first intermediate elements are positively connected to the second intermediate elements.

21. The brake disc/hub connection as claimed in claim 20, wherein
in a transition region between the section and at least one of the clamping bars, the first intermediate elements have a recess for the positive acceptance of a tongue which is bent at an angle to a contact surface of the second intermediate elements.

22. The brake disc/hub connection as claimed in claim 21, wherein
the contact surfaces of the second intermediate elements are wedge-shaped.

23. The brake disc/hub connection as claimed in claim 18, wherein
free ends of the sections of the first intermediate elements extend approximately radially with respect to the axis of rotation, which are formed as retaining bars and which are bent inwards and extend axially with respect to the axis of rotation, and
the free ends are radially supported on the lateral edges of the sections of the second intermediate elements.

24. The brake disc/hub connection as claimed in claim 20, wherein
free ends of the sections of the first intermediate elements extend approximately radially with respect to the axis of rotation, which are formed as retaining bars and which are bent inwards and extend axially with respect to the axis of rotation, and
the free ends are radially supported on the lateral edges of the sections of the second intermediate elements.

25. The brake disc/hub connection, comprising:
a hub with a wheel flange and drivers which extend from the wheel flange in the axial direction with respect to an axis of rotation of the hub;
a brake disc from an inner circumference of which support elements extend in the direction of the axis of rotation,
wherein the drivers engage in a toothed manner between the support elements;
first intermediate elements with sections arranged between lateral flanks of the drivers and the support elements,
wherein the first intermediate elements are in planar contact with mutually opposite lateral flanks of the drivers,
wherein the lateral flanks of the drivers and lateral flanks of the support elements are formed at an angle to each other, and the sections of the first intermediate elements in planar contact between the flanks of the drivers and the support elements are wedge-shaped.

26. The brake disc/hub connection as claimed in claim 25, wherein
a crossbar of the first intermediate elements connecting the sections to each other is in contact with a rear side of the drivers facing a wheel flange of the hub.

27. The brake disc/hub connection as claimed in claim 25, wherein
the lateral flanks of the drivers are oriented at an angle of 10° to 35° to the lateral flanks of the support elements.

28. The brake disc/hub connection as claimed in claim 25, wherein
the sections of the first intermediate elements in planar contact between the flanks of the drivers and the support elements are configured to taper away from the axis of rotation.

29. The brake disc/hub connection, comprising:
a hub with a wheel flange and drivers which extend from the wheel flange in the axial direction with respect to an axis of rotation of the hub;
a brake disc from an inner circumference of which support elements extend in the direction of the axis of rotation,
wherein the drivers engage in a toothed manner between the support elements;
intermediate elements with sections arranged between lateral flanks of the drivers and the support elements,
wherein sections of two of the intermediate elements are arranged between the lateral flanks of the drivers and the support elements in each case,
wherein each of the intermediate elements has a spring tongue extending at an angle to the respective section,
wherein the spring tongue of a first of the intermediate elements is in contact with a front surface of the respective support element and the spring tongue of a second of the intermediate elements is in contact with a rear contact surface of the respective support element.
